(19) United States
(12) Patent Application Publication
(10) Pub. No.: US 2011/0274452 A1
(43) Pub. Date: Nov. 10, 2011

(54) IMAGE FORMING APPARATUS AND PHOTOCONDUCTIVE MEMBER CLEANING METHOD IN THE IMAGE FORMING APPARATUS

(75) Inventors: Hirotaka Fukuyama, Shizuoka (JP); Sunao Takenaka, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/096,140

(22) Filed: Apr. 28, 2011

Related U.S. Application Data
(60) Provisional application No. 61/331,133, filed on May 4, 2010.

(51) Int. Cl. G03G 15/00; G03G 21/00

(52) U.S. Cl. 399/43; 399/71

(57) ABSTRACT

According to one embodiment, an image forming apparatus includes an image bearing member, a developing device, a cleaning executing section, and a potential adjusting section. An electrostatic latent image is formed on the image bearing member. The developing device stores a two-component developer including a toner and a carrier, includes a toner carrying member, which carries the two-component developer, arranged to be opposed to the image bearing member, and forms a toner image corresponding to the electrostatic latent image on the surface of the image bearing member. The cleaning executing section performs cleaning of the image bearing member. The potential adjusting section adjusts, during the cleaning, development contrast potential, which is a potential difference between the electrostatic latent image potential of the image bearing member and the potential of the developing device, such that the carrier adheres to the image bearing member together with the toner.

### CROSS-REFERENCE TO RELATED APPLICATIONS

This application is based upon and claims the benefit of priority from Provisional U.S. Application No. 61/331133, filed on 4 May 2010, the entire contents of which are incorporated herein by reference.

### FIELD

Embodiments described herein relate generally to an image forming apparatus and a photoconductive member cleaning method in the image forming apparatus.

### BACKGROUND

An image forming apparatus of an electrophotographic system has a process for supplying a toner, which is an image visualizing agent, to an electrostatic latent image, which is formed on a photoconductive member rotating in one direction, from a developing device to visualize the electrostatic latent image, transferring a toner image formed by the visualization onto recording paper, and fixing the toner image on the recording paper.

In such an image forming apparatus, introduction of a toner fixed at low temperature is in progress for energy saving. On the other hand, there is also a demand for the extension of life of consumables for a reduction in running cost.

However, in the fixing of the toner at low temperature, adhesion to the surface of a photoconductive member (filming) tends to occur. In such a case, it is effective to adopt a cleaning method for actively polishing the photoconductive member by adding an externally added agent such as silica particulates or metal oxide particulates to toner particles. However, this method leads to a reduction in life of the photoconductive member. Therefore, it is necessary to always use the toner taking into account a balance between both characteristics of the filming on the photoconductive member and the wear of the photoconductive member.

### BRIEF DESCRIPTION OF THE DRAWINGS

FIG. 1 is a schematic diagram of an image forming apparatus according to an embodiment;

FIG. 2 is a diagram for explaining an image forming process in an image forming section shown in FIG. 1;

FIG. 3 is a functional block diagram of the embodiment;

FIG. 4 is a graph for explaining a relation between development contrast potential and image density;

FIG. 5 is a graph for explaining a relation between the development contrast potential and a solid carrier adhesion amount;

FIG. 6 is a diagram of a state during a cleaning mode in the image forming section shown in FIG. 1;

FIG. 7 is a flowchart for explaining a specific example of a photoconductive member cleaning method in the image forming apparatus; and

FIG. 8 is a diagram for explaining effects of the cleaning mode realized when continuous printing is performed.

### DETAILED DESCRIPTION

According to one embodiment, an image forming apparatus includes an image bearing member, a developing device, a cleaning executing section, and a potential adjusting section.

An electrostatic latent image is formed on the image bearing member. The developing device stores a two-component developer including a toner and a carrier, includes a toner carrying member, which carries the two-component developer, arranged to be opposed to the image bearing member, and forms a toner image corresponding to the electrostatic latent image on the surface of the image bearing member.

The cleaning executing section performs cleaning of the image bearing member. The potential adjusting section adjusts, during the cleaning, development contrast potential, which is a potential difference between the electrostatic latent image potential of the image bearing member and the potential of the developing device, such that the carrier adheres to the image bearing member together with the toner.

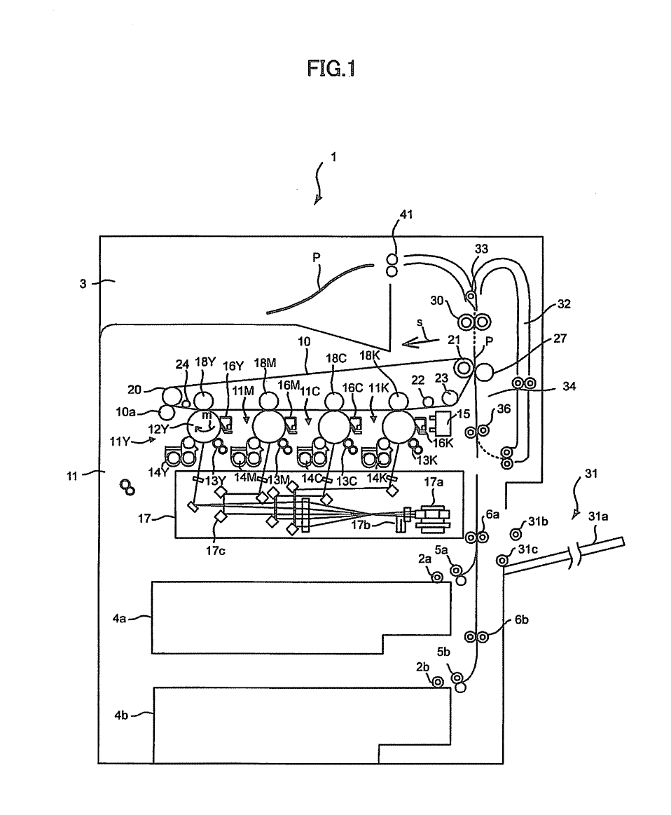

FIG. 1 is a schematic diagram of an image forming apparatus 1 according to an embodiment. As shown in FIG. 1, the image forming apparatus 1 is an image forming apparatus of a quadruple tandem system. The image forming apparatus 1 includes a paper discharge section 3 in an upper part of the image forming apparatus 1. The image forming apparatus 1 includes an image forming section 11 on the lower side of an intermediate transfer belt 10. The image forming section 11 includes four sets of image forming sections 11Y, 11M, 11C, and 11K arranged in parallel along the intermediate transfer belt 10. The image forming sections 11Y, 11M, 11C, and 11K respectively form toner images of yellow (Y), magenta (M), cyan (C), and black (K). A temperature and humidity sensor 15, which is an environment detecting section, is provided near the image forming section 11 of the image forming apparatus 1.

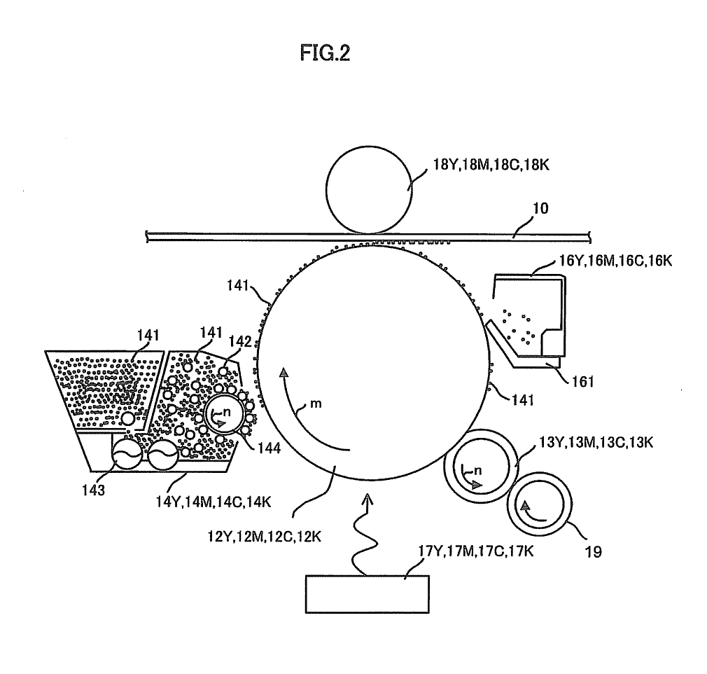

FIG. 2 is a diagram for explaining an image forming process in the image forming section 11 shown in FIG. 1. As shown in FIG. 2, the image forming sections 11Y, 11M, 11C, and 11K respectively include photoconductive members 12Y, 12M, 12C, and 12K, which are image bearing members. The photoconductive members 12Y, 12M, 12C, and 12K rotate in an arrow m direction. Charging devices 13Y, 13M, 13C, and 13K, developing devices 14Y, 14M, 14C, and 14K, and photoconductive member cleaners 16Y, 16M, 16C, and 16K are respectively arranged around the photoconductive members 12Y, 12M, 12C, and 12K along the rotating direction.

The charging devices 13Y, 13M, 13C, and 13K are charged by being applied with a charging voltage from a power supply (not shown) connected to the charging devices 13Y, 13M, 13C, and 13K. The charging devices 13Y, 13M, 13C, and 13K respectively rotate according to the rotation of the photoconductive members 12Y, 12M, 12C, and 12K. The photoconductive members 12Y, 12M, 12C, and 12K are uniformly charged in a non-contact manner. Cylindrical charging roller cleaners 19, which rotate reversely to charging rollers, are set in contact with the charging devices 13Y, 13M, 13C, and 13K. Foreign matters such as toners and dust adhering to the charging rollers are removed. The charging roller cleaners 19 are formed of, for example, sponge.

Exposure lights emitted by laser exposing devices 17 are respectively irradiated between the charging devices 13Y, 13M, 13C, and 13K and the developing devices 14Y, 14M, 14C, and 14K around the photoconductive members 12Y, 12M, 12C, and 12K. The laser exposing devices 17 scan laser beams, which are emitted from semiconductor laser elements, in the axis direction of the photoconductive members 12Y, 12M, 12C, and 12K. The laser exposing devices 17 include polygon mirrors 17a, imaging lens systems 17b, and mirrors 17c. Electrostatic latent images are formed on the photoconductive members 12Y, 12M, 12C, and 12K by the laser exposing devices 17.

The developing devices 14Y, 14M, 14C, and 14K develop the electrostatic latent images on the photoconductive members 12Y, 12M, 12C, and 12K. The developing devices 14Y, 14M, 14C, and 14K perform development with two-component developers including toners 141 of colors yellow (Y), magenta (M), cyan (C), and black (K) and a carrier 142, which are developers. A developing process in the image forming section 11Y is explained below as an example. When the two-component developer is agitated by a mixer 143 in a developer storing section, the toner 141 and the carrier 142 in the developer rub against each other to be charged. The developer charged to a predetermined charging amount is led from the developer storing section to a rotating developing sleeve and a developing roller 144 fixed on the inside of the developing sleeve and including a magnet having plural magnetic poles. The developer supplied to the surface of the developing roller 144 is retained in a magnetic brush state, conveyed by the rotation of the developing roller 144, and, after passing a doctor blade (a regulating member) arranged near the outer circumference of the developing roller 144, conveyed to a developing nip section in a position opposed to the photoconductive member 12Y. In the developing nip section, the developer on the developing roller 144 is moved to the surface of the photoconductive member 12Y by electrostatic force and develops an electrostatic latent image. At this point, in a non-image forming area and an image forming area for forming an electrostatic latent image of the developing roller 144, a bias voltage for leading in and supplying the toner 141 is applied to the image forming area. Only the toner 141 is deposited in the image forming area of the photoconductive member 12Y. The same developing process is performed in the image forming sections 11M, 11C, and 11K.

The carrier 142 is a magnetic carrier having average circularity equal to or higher than 0.85. It is suitable to use a resin carrier including a magnetic carrier core and a resin component as the magnetic carrier because it is possible to prevent the surfaces of the photoconductive members 12Y, 12M, 12C, and 12K to be polished more than necessary during the cleaning mode.

A value of the circularity of the carrier 142 is obtained by measurement using a flow-type particle image analyzing apparatus. Specifically, a particle diameter as a circle-equivalent diameter is measured concerning particles within a range of a circle-equivalent diameter of 0.60 to 400 μm. The circularities of the measured particles are calculated by Formula (1). A value obtained by dividing a sum of the circularities by the number of all particles is set as circularity. The measurement is performed concerning 1000 to 1500 particles and a calculated value is set as average circularity.

n=1/m (1)

In Formula (1), n represents circularity, 1 represents the circumferential length of a circle having a projection area same as that of a particle image, and m represents the circumferential length of a projected image of the particles.

In this embodiment, the flow-type particle image analyzing apparatus means a device that photographs a particle image and calculates, from an area of a two-dimensional image of each of particles, a diameter of a circle having an area same as the area as a circle-equivalent diameter. The measurement of toner particles by the flow-type particle image analyzing apparatus can be performed by using, for example, a flow-type particle image analyzing apparatus FPIA2100 manufactured by Sysmex Corporation.

The intermediate transfer belt 10 is stretched and suspended by a backup roller 21, a driven roller 20, and first to third tension rollers 22 to 24 and rotated in an arrow s direction. The intermediate transfer belt 10 is opposed to and in contact with the photoconductive members 12Y, 12M, 12C, and 12K. Primary transfer rollers 18Y, 18M, 18C, and 18K are provided in positions of the intermediate transfer belt 10 opposed to the photoconductive members 12Y, 12M, 12C, and 12K.

The primary transfer rollers 18Y, 18M, 18C, and 18K primarily transfer toner images formed on the photoconductive members 12Y, 12M, 12C, and 12K onto the intermediate transfer belt 10. The photoconductive cleaners 16Y, 16M, 16C, and 16K bring distal end portions of cleaning blades 161 into contact with the surfaces of the photoconductive members 12Y, 12M, 12C, and 12K after the primary transfer, remove deposits such as toners, a carrier, and an externally added agent remaining on the surfaces, and collect the deposits in a waste toner storage box.

A secondary transfer section supported by the backup roller 21 of the intermediate transfer belt 10 is arranged to be opposed to a secondary transfer roller 27. In the secondary transfer section, predetermined secondary transfer bias is applied to the backup roller 21. When sheet paper P passes between the intermediate transfer belt 10 and the secondary transfer roller 27, a toner image on the intermediate transfer belt 10 is secondarily transferred onto the sheet paper P. The sheet paper P is fed from paper feeding cassettes 4a and 4b or a manual feed mechanism 31. After the secondary transfer ends, the intermediate transfer belt 10 is cleaned by a belt cleaner 10a.

Pickup rollers 2a and 2b, separating rollers 5a and 5b, conveying rollers 6a and 6b, and a registration roller pair 36 are provided between the paper feeding cassettes 4a and 4b and the secondary transfer roller 27. A manual feed pickup roller 31b and a manual feed separating roller 31c are provided between a manual feed tray 31a of the manual feed mechanism 31 and the registration roller pair 36. Further, a fixing device 30 is provided further downstream than the secondary transfer section along the direction of a vertical conveying path 34. The fixing device 30 fixes the toner image, which is transferred onto the sheet paper P in the secondary transfer section, on the sheet paper P. A gate 33 configured to divert the sheet paper P to the direction of a paper discharge roller 41 or the direction of a re-conveying unit 32 is provided downstream of the fixing device 30. The sheet paper P led to the paper discharge roller 41 is discharged to the paper discharge section 3. The sheet paper P led to the re-conveying unit 32 is led in the direction of the secondary transfer roller 27 again.

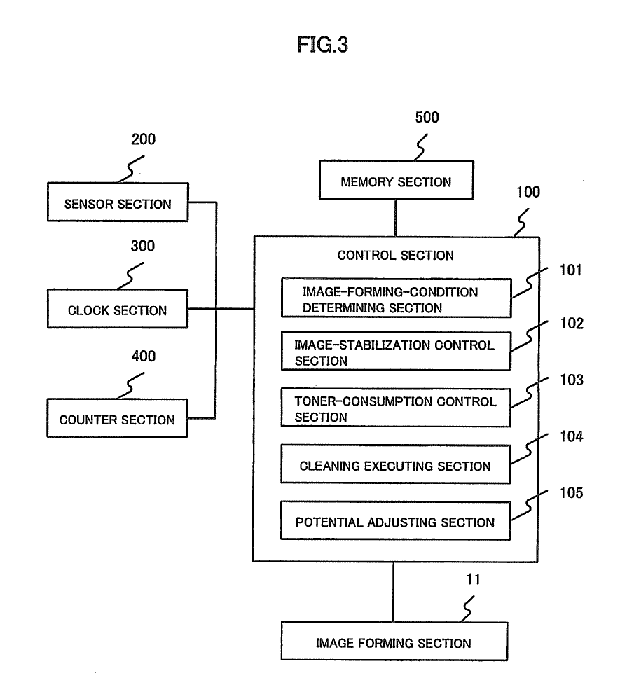

FIG. 3 is a functional block diagram of the image forming apparatus 1 according to this embodiment. As shown in FIG. 3, in the image forming apparatus 1, the image forming section 11, a sensor section 200, a clock section 300, a counter section 400, and a memory section 500 are connected to a control section 100 configured to perform control of the image forming apparatus 1.

The image forming section 11 performs image formation on the basis of image forming conditions determined by the control section 100. The sensor section 200 includes various sensors provided to acquire environmental values such as relative humidity, a toner residual amount, and the like. The clock section 200 acquires, according to a request from the control section 100, non-operation times and operation times of the devices included in the image forming apparatus 1. The counter section 300 acquires the number of processed sheets processed by a supplied developer (developer life). The memory section 500 stores, together with the environmental value such as the relative humidity and the developer life, a correlation between the environmental values and developer life and image forming conditions such as development contrast potential, which is a difference between toner adhering side electrostatic latent image potential and development potential.

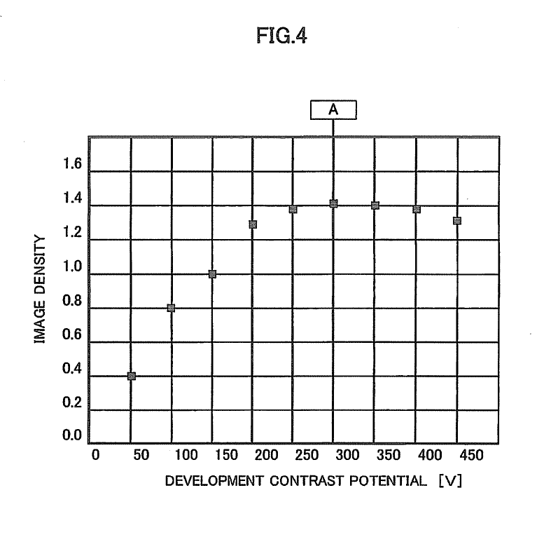

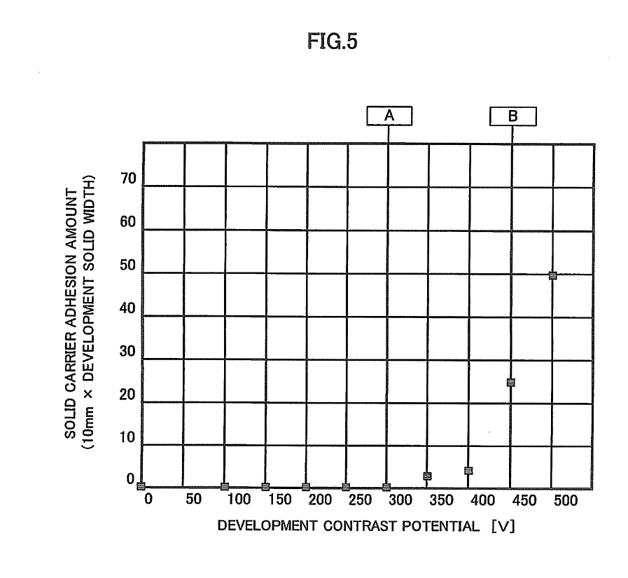

FIG. 4 is graph for explaining a relation between the development contrast potential and image density. In FIG. 4, the image density increases as the development contrast potential increases. However, from the vicinity of 300 V, the image density tends to level off or slightly decrease even if the development contrast potential increases. FIG. 5 is a graph for explaining a relation between the development contrast potential and a solid carrier adhesion amount. In FIG. 4, up to the vicinity of 300 V, adhesion of a solid carrier to the photoconductive members 12Y, 12M, 12C, and 12K does not occur even if the development contrast potential increases. However, if the development contrast potential further increases, the solid carrier adhesion amount suddenly increases. These correlations are stored in the memory section 500 in advance and used in processing by the control section 100 explained later.

The control section 100 includes an image-forming-condition determining section 101, an image-stabilization control section 102, a toner-consumption control section 103, a cleaning executing section 104, and a potential adjusting section 105.

The image-forming-condition determining section 101 determines image forming conditions on the basis of output information from the image-stabilization control section 102, the toner-consumption control section 103, and the cleaning executing section 104 and outputs the image forming conditions to the image forming section 11.

The image-stabilization control section 102 executes image stabilization control on the basis of an analysis result of predetermined parameters such as the number of printed sheets, a printing ratio, a start time, environmental values (temperature and humidity) and outputs information concerning the image stabilization control to the image-forming-condition determining section 101. The image stabilization control is control for calculating image density of a pattern image formed on the intermediate transfer belt 10, comparing the image density with target density set in advance, and optimizing image forming conditions such as development bias until the image density reaches desired target density. For example, referring to FIGS. 4 and 5, it is suitable to set the development contrast potential to 300 V because sufficient image density is obtained and adhesion of the solid carrier to the photoconductive members 12Y, 12M, 12C, and 12K does not occur.

The toner-consumption control section 103 executes forced toner consumption (refresh) for forcibly causing the image forming apparatus 1 to consume a toner for the purpose of replacing a part of a toner that causes a fall in a charging amount in which a change in the charging amount tends to occur. The forced toner consumption is performed by analyzing values of sensors and the like to determine whether a developer is stored in a long-term non-operation or high humidity environment. In this embodiment, as the environmental value, relative humidity having relatively large influence on a charging amount of a toner is cited as an example. However, the environmental value may be other conditions such as temperature. For example, when fluctuation in the environmental value such as the relative humidity is small, execution conditions for the forced toner consumption may be determined on the basis of other parameters that affect the charging amount of the toner. For example, the execution conditions may be determined on the basis of a non-operation time before image formation. The non-operation time can be acquired by the clock section 300. Further, the execution conditions may be determined on the basis of developer life. The developer life can be acquired by the counter section 400.

Such prediction of the execution conditions for the forced toner consumption is desirably performed every time image formation is started. The prediction may be set to be executed when predetermined non-operation time or the developer life is exceeded. After the execution of the forced toner consumption, the image-stabilization control section 102 executes the image stabilization control, whereby a stable image can be obtained in printing after the execution of the forced toner consumption. Specified latent images for inspection are respectively formed on the photoconductive members 12Y, 12M, 12C, and 12K and developed and density (an adhesion amount) of the latent images is measured on the intermediate transfer belt 10, whereby image forming conditions such as development contrast potential, charging bias voltage, and exposure intensity are optimized.

The cleaning executing section 104 analyzes predetermined parameters acquired in execution of a print job, performs determination of execution of the cleaning mode for the photoconductive members 12Y, 12M, 12C, and 12K and, if the cleaning mode is executed, requests the development-contrast-potential adjusting section 105 to perform potential adjustment based on a determination result. In this embodiment, the cleaning executing section 104 performs the determination of execution of the cleaning mode on the basis of at least one item of the number of printed sheets counted from last execution time of the cleaning mode, printing driving time in which the developing devices 14Y, 14M, 14C, and 14K and the photoconductive members 12Y, 12M, 12C, and 12K are driven from the start of the print job, and a printing ratio of the print job.

The potential adjusting section 105 adjusts biases applied to the photoconductive members 12Y, 12M, 12C, and 12K and the developing devices 14Y, 14M, 14C, and 14K to adjust development contrast potential, which is a potential difference between the electrostatic latent image potential of the photoconductive members 12Y, 12M, 12C, and 12K and the potential of the developing devices 14Y, 14M, 14C, and 14K.

During the execution of the cleaning mode, the potential adjusting section 105 adjusts the development contrast potential such that the carrier 142 adheres to the surfaces of the photoconductive members 12Y, 12M, 12C, and 12K together with the toners 141. In this embodiment, an absolute value of the development contrast potential in the cleaning mode is adjusted to a value larger than an absolute value of the potential set by the image stabilization control by the image-stabilization control section 102. For example, referring to a B part in FIG. 5, it is seen that it is possible to cause adhesion of the solid carrier to the photoconductive members 12Y, 12M, 12C and 12K if the development contrast potential is set to 450 V exceeding 300 V set during the image stabilization control by the image-stabilization control section 102.

It is suitable to set the execution time of the cleaning mode to a short time from the viewpoint of preventing wear of the photoconductive members 12Y, 12M, 12C, and 12K. Further, during the execution of the cleaning mode, it is suitable to omit the primary transfer by the primary transfer rollers 18Y, 18M, 18C, and 18K and remove and collect residual toners and an adhering carrier on the photoconductive members 12Y, 12M, 12C, and 12K using the photoconductive cleaners 16Y, 16M, 16C, and 16K because scattering of the residual toners and the residual carrier can be prevented. As means for omitting the primary transfer, there is a method of not bringing the photoconductive members and the intermediate transfer belt into contact with each other, not applying primary transfer high voltage, applying high voltage lower than that during a normal printing operation as the primary transfer high voltage, or the like.

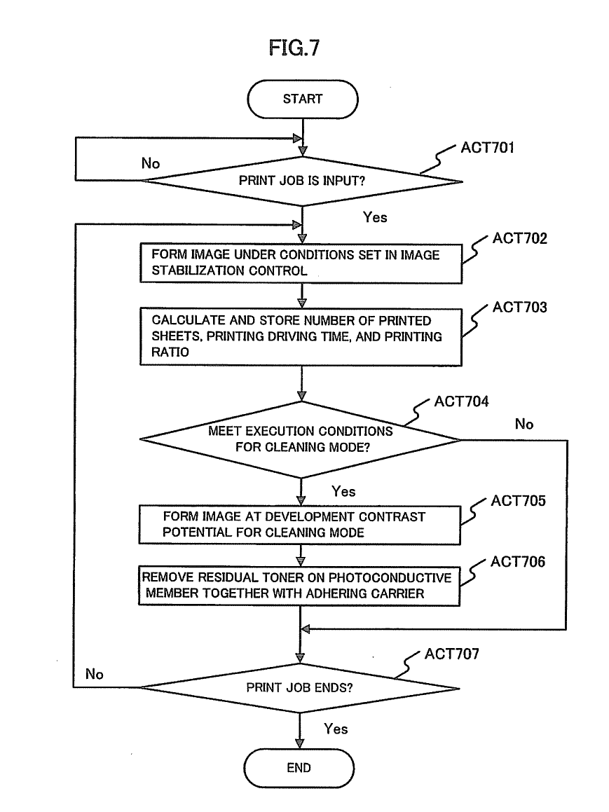

A photoconductive member cleaning method in the image forming apparatus 1 configured as explained above is explained with reference to a flowchart of FIG. 7. In the following explanation, it is assumed that the image stabilization control is executed beforehand by the image-stabilization control section 102.

In Act 701, the image-forming-condition determining section 101 determines presence or absence of input of a print job. If it is determined that a print job is input (Yes in Act 701), the image-forming-condition determining section 101 proceeds to Act 702. If it is determined that a print job is not input (No in Act 701), the image-forming-condition determining section 101 is put on standby.

In Act 702, the image-forming-condition determining section 101 outputs image forming conditions set in the image stabilization control executed last by the image-stabilization control section 102 and stored in the memory section 500 to the image forming section 11 and causes the image forming section 11 to execute image formation processing.

In Act 703, the counter section 400 stores the number of printed sheets counted during execution of the print job in the memory section 500. The clock section 300 stores printing driving time in which the developing devices and the image bearing members are driven from the start of the print job in the memory section 500. The image-forming-condition determining section 101 calculates a printing ratio of the print job and stores the printing ratio in the memory section 500.

In Act 704, the cleaning executing section 104 acquires the number of printed sheets, the printing driving time, and the printing ratio stored in the memory section 500 and determines whether the number of printed sheets, the printing driving time, and the printing ratio meet predetermined cleaning mode execution conditions. If it is determined that the number of printed sheets, the printing driving time, and the printing ratio meet the cleaning mode execution conditions (Yes in Act 704), the cleaning executing section 104 proceeds to Act 705. If it is determined that the number of printed sheets, the printing driving time, and the printing ratio do not meet the cleaning mode execution conditions (No in Act 704), the cleaning executing section 104 proceeds to Act 707.

In Act 705, the cleaning executing section 104 requests the potential adjusting section 105 to change the development contrast potential to development contrast potential for the cleaning mode. According to the request, the potential adjusting section 105 adjusts the development contrast potential such that the carrier 142 adheres to the photoconductive members 12Y, 12M, 12C, and 12K together with the toners 141. Specifically, the potential adjusting section 105 appropriately adjusts development bias and charging bias such that the development contrast potential is adjusted. The image forming section 11 performs image formation under the potential conditions after the adjustment. A toner image to be formed is suitably an image for the cleaning mode having high cleaning efficiency defined in advance. When execution of the cleaning mode is started, the printing job in execution is temporarily suspended. However, since an actual print job of the image forming apparatus 1 is divided into plural processing blocks, before and after which a start sequence and an end sequence are provided, it is suitable if the cleaning mode is started after the processing blocks end.

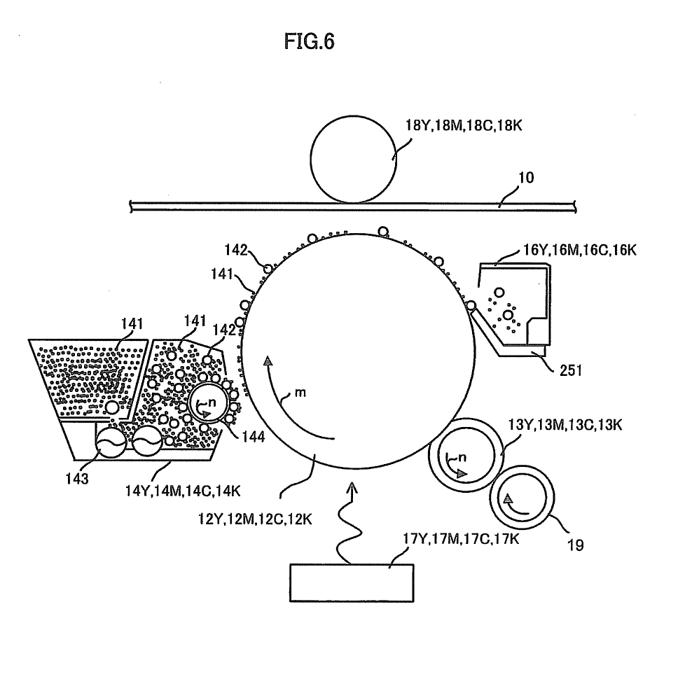

In Act 706, the photoconductive member cleaners 16Y, 16M, 16C, and 16K respectively remove the residual toners 141 on the photoconductive members 12Y, 12M, 12C, and 12K together with the adhering carrier 142. FIG. 6 is a diagram of a state during the cleaning mode in the image forming section shown in FIG. 1.

In Act 707, the image-forming-condition determining section 101 determines whether the print job ends. If it is determined that the print job ends (Yes in Act 707), the image-forming-condition determining section 101 ends the cleaning mode. If it is determined that the print job does not end (No in Act 707), the image-forming-condition determining section 101 returns to Act 702 and repeats the processing in Act 702 to Act 707 until the print job ends.

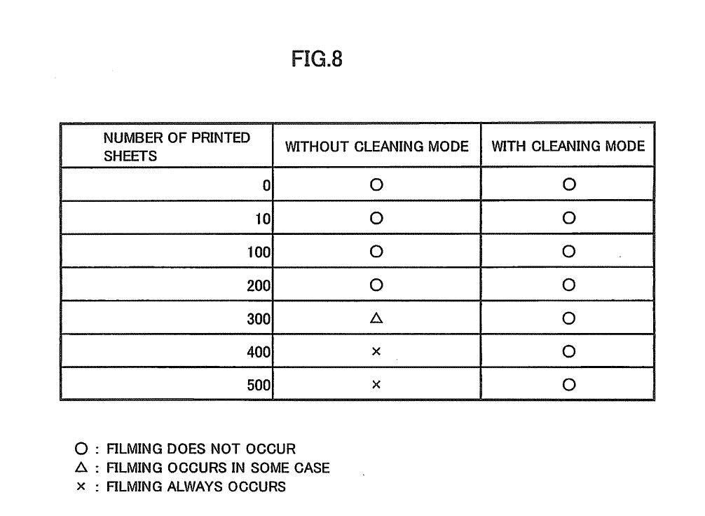

As explained above, with the image forming apparatus 1 according to this embodiment, the development contrast potential is adjusted under predetermined conditions and the carrier 142 is deposited on the surface of the photoconductive members 12Y, 12M, 12C, and 12K together with the toners 141. Therefore, the carrier 142 having a large diameter compared with that of the toners 141 is mixed in the toners 141. Therefore, polishing force of cleaning blades 251 is improved by the presence of the carrier 142 and it is possible to prevent the residual toners 141 from slipping through spaces between the cleaning blades 251 and the photoconductive members 12Y, 12M, 12C, and 12K. Therefore, it is possible to prevent occurrence of adhesion (filming). Further, efficiency of photoconductive member cleaning is improved. FIG. 8 is a diagram for explaining effects of the cleaning mode realized when continuous printing is performed. In FIG. 8, in the case of the image forming apparatus in the past without the cleaning mode, filming occurs when the number of printed sheets exceeds 300. However, in the image forming apparatus 1 according to this embodiment having the cleaning mode, occurrence of filming is prevented. There is a method of preventing filming using a toner externally added agent. However, this method always facilitates wear of the photoconductive members and causes short life of the photoconductive members. On the other hand, the image forming apparatus according to this embodiment facilitates wear of the photoconductive members only when it is determined that refresh of the surfaces of the photoconductive members is necessary. Therefore, it is possible to prevent unnecessary wear of the photoconductive members and prevent short life of the photoconductive members.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form o the apparatus and methods described herein may be made without departing from the spirit of the inventions. The accompanying claims and there equivalents are intended to cover such forms of modifications as would fall within the scope and spirit of the invention.

What is claimed is:

1. An image forming apparatus comprising:
an image bearing member on which an electrostatic latent image is formed;
a developing device configured to store a two-component developer including a toner and a carrier, include a toner carrying member, which carries the two-component developer, arranged to be opposed to the image bearing member, and form a toner image corresponding to the electrostatic latent image on a surface of the image bearing member;
a cleaning executing section configured to perform cleaning of the image bearing member; and
a potential adjusting section configured to adjust, during the cleaning, development contrast potential, which is a potential difference between electrostatic latent image potential of the image bearing member and potential of the developing device, such that the carrier adheres to the image bearing member together with the toner.

2. The apparatus according to claim 1, wherein the potential adjusting section adjusts an absolute value of the development contrast potential in the cleaning to a value larger than an absolute value of potential set during image stabilization control.

3. The apparatus according to claim 2, wherein the cleaning executing section performs determination of execution of the cleaning on the basis of a number of printed sheets counted during execution of a print job.

4. The apparatus according to claim 2, wherein the cleaning executing section performs determination of execution of the cleaning on the basis of a printing driving time in which the developing device and the image bearing member are driven from start of a print job.

5. The apparatus according to claim 2, wherein the cleaning executing section performs determination of execution of the cleaning on the basis of a printing ratio of a print job.

6. The apparatus according to claim 2, wherein the cleaning executing section performs determination of execution of the cleaning on the basis of at least one item of a number of printed sheets counted during execution of a print job, a printing driving time in which the developing device and the image bearing member are driven from start of the print job, and a printing ratio of the print job.

7. The apparatus according to claim 6, wherein the carrier is a magnetic carrier having average circularity equal to or higher than 0.85.

8. The apparatus according to claim 7, wherein the carrier is a resin carrier including a magnetic carrier core and a resin component.

9. The apparatus according to claim 8, further comprising a cleaning device configured to collect, together with the carrier, the toner remaining on the surface of the image bearing member.

10. The apparatus according to claim 9, wherein the cleaning device includes:
a cleaning blade configured to come into contact with the surface of the image bearing member at a distal end portion and scrape off the toner and the carrier adhering to the surface of the image bearing member; and
a waste toner collecting box configured to store the toner and the carrier scraped of f by the cleaning blade.

11. A photoconductive member cleaning method in an image forming apparatus comprising:
providing a developing device configured to store a two-component developer including a toner and a carrier and include a toner carrying member, which carries the two-component developer, in a position where the toner bearing member is opposed to an image bearing member on which an electrostatic latent image is formed and forming a toner image corresponding to the electrostatic latent image on a surface of the image bearing member;
performing cleaning of the image bearing member; and
adjusting, during the cleaning, development contrast potential, which is a potential difference between electrostatic latent image potential of the image bearing member and potential of the developing device, such that the carrier adheres to the image bearing member together with the toner.

12. The method according to claim 11, further comprising adjusting an absolute value of the development contrast potential in the cleaning to a value larger than an absolute value of potential set during image stabilization control.

13. The method according to claim 12, further comprising performing determination of execution of the cleaning on the basis of a number of printed sheets counted from last execution time of the cleaning.

14. The method according to claim 12, further comprising performing determination of execution of the cleaning on the basis of a printing driving time in which the developing device and the image bearing member are driven from start of a print job.

15. The method according to claim 12, further comprising performing determination of execution of the cleaning on the basis of a printing ratio of a print job.

16. The method according to claim 12, further comprising performing determination of execution of the cleaning on the basis of at least one item of a number of printed sheets counted from last execution time of the cleaning, a printing driving time in which the developing device and the image bearing member are driven from start of a print job, and a printing ratio of the print job.

17. The method according to claim 16, wherein the carrier is a magnetic carrier having average circularity equal to or higher than 0.85.

18. The method according to claim 17, wherein the carrier is a resin carrier including a magnetic carrier core and a resin component.

19. The method according to claim 18, further comprising collecting, together with the carrier, the toner remaining on the surface of the image bearing member in a cleaning device provided on a downstream side in a rotating direction of the image bearing member.

20. The method according to claim 19, further comprising, in the cleaning device, bringing the surface of the image bearing member and a distal end portion of a cleaning blade into contact with each other, scraping off the toner and the carrier adhering to the surface of the image bearing member, and storing the toner and the carrier scraped off by the cleaning blade in a waste toner collection box.
